(19) United States
(12) Patent Application Publication
(10) Pub. No.: US 2026/0233511 A1
(43) Pub. Date: Aug. 13, 2026

(54) Ink Station Washing Assembly For A Can Decorator, Ink Station Roller Assembly For A Can Decorator, And Methods Of Making, Using, And Cleaning Same

(71) Applicant: Stolle Machinery Company, LLC, Centennial, CO (US)

(72) Inventors: Leonard Joel Archuleta, Westminster, CO (US); Stephen Dane Christensen, Highlands Ranch, CO (US); Bryon L. Kajfosz, Littleton, CO (US)

(73) Assignee: Stolle Machinery Company, LLC, Centennial, CO (US)

(21) Appl. No.: 19/049,475

(22) Filed: Feb. 10, 2025

(51) Int. Cl. B41F 35/04; B08B 1/16; B08B 1/52

(52) U.S. Cl. CPC B41F 35/04; B08B 1/165; B08B 1/52

(57) ABSTRACT

An ink station washing assembly includes a frame with a first end and an opposing second end. A scraper is disposed between the first end and the second end of the frame. One or more washing nozzles are disposed on the frame between the first end of the frame and the second end of the frame. The scraper moves between a first position and a second position. In the first position, the scraper is retracted relative to the frame so that a can decorator is uncontacted by the scraper when the scraper is in the first position. In the second position, the scraper is extended relative to the frame so that the scraper contacts an ink roller of a can decorator ink roller assembly when the scraper is in the second position to remove ink from a roller assembly of the can decorator.

### FIELD OF THE INVENTION

The disclosed concept relates generally to can decorators. More specifically, the invention relates to an ink station washing assembly for cleaning an ink station on a can decorator.

### BACKGROUND OF THE INVENTION

High speed continuous motion machines for decorating cans, commonly referred to as “can decorator machines” or simply “can decorators,” are generally well known. For example, U.S. Pat. Nos. 6,178,886, 6,367,380, and 10,739,705, each incorporated by reference herein, describe various can decorator methods, apparatuses, and systems.

As shown in FIG. 1, a can decorator 2 includes an infeed conveyor 15, which receives cans 16 from a can supply (not shown) and directs them to arcuate cradles or pockets 17 along the periphery of spaced parallel rings secured to a pocket wheel 12. The pocket wheel 12 is fixedly secured to a continuously rotating mandrel carrier wheel 18, which in turn is keyed to a continuously rotating horizontal drive shaft 19. Horizontal spindles or mandrels (not shown), each being pivotable about its own axis, are mounted to the mandrel carrier wheel 18 adjacent its periphery. Downstream from the infeed conveyor 15, each spindle or mandrel is in closely spaced axial alignment with an individual pocket 17, and undecorated cans 16 are transferred from the pockets 17 to the mandrels. Suction applied through an axial passage of the mandrel draws the can 16 to a final seated position on the mandrel.

While mounted on a mandrel, each can 16 is decorated by being brought into engagement with a blanket (e.g., without limitation, a replaceable adhesive-backed piece of rubber) disposed on a blanket wheel of the multicolor printing unit indicated generally by reference numeral 22. Thereafter, and while still mounted on the mandrels, the outside of each decorated can 16 is coated with a protective film of varnish applied by engagement with the periphery of a varnish applicator roll (not shown) rotating on a shaft 23 in the overvarnish unit indicated generally by reference numeral 24. Cans 16 with decorations and protective coatings thereon are then transferred from the mandrels to suction cups (not shown) mounted adjacent the periphery of a transfer wheel (not shown) rotating on a shaft 28 of a transfer unit 27. From the transfer unit 27 the cans 16 are deposited on generally horizontal pins 29 carried by a chain-type output conveyor 30, which carries the cans 16 through a curing oven (not shown).

While moving toward engagement with an undecorated can 16, the blanket engages a plurality of printing cylinders 31, each of which is associated with an individual ink station assembly 32 (an exemplary eight ink station assemblies 32 are shown in FIG. 1). Typically, each assembly 32 provides a different color ink and each printing cylinder 31 applies a different ink image segment to the blanket. All of the “ink image” segments combine to produce a “main image” that is structured to be applied to the can body. The “main image” is then transferred to undecorated cans 16 and becomes, as used herein, the “can body applied image.” Each ink station assembly 32 includes a plurality of rollers, or as used herein, “rolls,” that are structured to transfer a quantity of ink from a reservoir, or as used herein an “ink fountain,” to the blanket. The path that the ink travels is, as used herein, identified as the “ink train.” That is, the rolls over which the ink travels define the “ink train.” Further, as used herein, the “ink train” has a direction with the ink fountain being at the “upstream” end of the ink train and a printing cylinder 31 at the “downstream” end of the ink train.

The ink train extends over a number of rolls each of which has a purpose. As shown, the ink train starts at the ink fountain and is initially applied as a film to a fountain roll. The fountain roll is intermittently engaged by a ductor roll. When the ductor roll engages the fountain roll, a quantity of ink is transferred to the ductor roll. The ductor roll also intermittently engages a downstream roll and transfers ink thereto. The ductor roll has a “duty cycle” which, as used herein, means the ratio of the duration of the ductor roller being in contact with the fountain roller divided by the duration of a complete cycle (ductor roller in contact with the fountain roller, move to the first downstream roller, contact with first steel roller, and move back to fountain roller).

The other rolls include, but are not limited to, distribution roll(s), oscillator roll(s), and transfer roll(s). Generally, these rolls are structured to distribute the ink so that a proper amount of ink is generally evenly applied to the printing cylinder 31. For example, the oscillator rolls are structured to reciprocate longitudinally about their axis of rotation so as to spread the ink as it is applied to the next downstream roll. The final roll is the printing cylinder 31 which applies the ink to the blanket. It is understood that each ink station assembly 32 applies an “ink image” of a single selected color to the blanket and that each ink station assembly 32 must apply an ink image in a proper position relative to the other ink images so that the main image does not have offset ink images.

Thus, as used herein, an “ink image” means the image of a single ink color which is part of a “main image.” As used herein, a “main image” means an image created from a number of ink images and which is the image that is applied to a can body as the “can body applied image.” It is understood that a “main image” includes a number, and typically a plurality, of ink images. For example, if the main image was the French flag (which is a tricolor flag featuring three vertical bands colored blue (hoist side), white, and red), an ink station assembly 32 with blue ink would provide an ink image that is a blue rectangle, an ink station assembly 32 with white ink would provide an ink image that is a white rectangle and an ink station assembly 32 with red ink would provide an ink image that is a red rectangle. Further, presuming that the main image was of a French flag with the hoist side on the left, the ink station assembly 32 with blue ink would provide the blue rectangle ink image on the left side of the blanket, the ink station assembly 32 with white ink would provide the white rectangle ink image on the center of the blanket immediately adjacent the blue rectangle ink image, and the ink station assembly 32 with red ink would provide the red rectangle ink image on the right side of the blanket immediately adjacent the white rectangle ink image. Once all the ink images are applied to the blanket, the main image is formed and then applied to a can body.

In the course of operating the can decorator, the ink rollers of the ink roller assembly will become coated with colored ink. After being coated, the ink rollers will need to be cleaned in order to prevent color contamination when the ink station assembly is used with a different color ink, such as when a new run of cans is processed through the can decorator. Currently, these ink rollers are cleaned manually by a human operator with hand tools like squeegees and scrapers. The hand tools were used to physically remove ink from the ink rollers so that a new color ink could be used with them. This solution is not efficient.

### SUMMARY OF THE INVENTION

These need for a more efficient mechanism and process, among other needs, are met by the presently disclosed technology, which provides an ink washing assembly for use with a can decorator.

In one exemplary embodiment of the presently disclosed technology, an ink station washing assembly can have a frame. The frame can have a first end and an opposing second end. A scraper can be disposed between the first end of the frame and the second end of the frame. A plurality of washing nozzles can also be disposed on the frame between the first end of the frame and the second end of the frame. The scraper may be configured to move between a first position and a second position. The first position is defined where the scraper is retracted relative to the frame such that a can decorator is uncontacted by the scraper when the scraper is in the first position. The second position is defined where the scraper is extended relative to the frame such that the scraper is configured to contact an ink roller of a can decorator ink roller assembly when the scraper is in the second position to remove ink from a roller assembly of the can decorator.

In another exemplary embodiment of the presently disclosed technology, an ink station roller assembly for a can decorator can include a plurality of ink rollers. The plurality of ink rollers can be configured to transfer ink onto a can body. The plurality of ink rollers is mounted onto an ink station assembly, forming an ink station roller assembly. An ink station washing assembly can be affixed to the ink station assembly. The ink station washing assembly can include a frame. The frame can have a first end and an opposing second end. A scraper can be disposed between the first end of the frame and the second end of the frame. A plurality of washing nozzles can also be disposed on the frame between the first end of the frame and the second end of the frame. The scraper may be configured to move between a first position and a second position. The first position is defined where the scraper is retracted relative to the frame such that a can decorator is uncontacted by the scraper when the scraper is in the first position. The second position is defined where the scraper is extended relative to the frame such that the scraper is configured to contact an ink roller of a can decorator ink roller assembly when the scraper is in the second position to remove ink from a roller assembly of the can decorator.

In a further exemplary embodiment of the presently disclosed technology, a method of cleaning rollers in an ink station roller assembly for a can decorator can include installing an ink station washing assembly into an ink station roller assembly. Further, the method can include moving the scraper of the ink station washing assembly from a first position to a second position such that the scraper is in contact with a target ink roller. Additionally, the method can include activating one or more of the plurality of nozzles such that a liquid is sprayed onto one or more ink rollers of the plurality of ink rollers.

### BRIEF DESCRIPTION OF THE DRAWINGS

A full understanding of the invention can be gained from the following description of the preferred embodiments when read in conjunction with the accompanying drawings in which:

FIG. 1 is a side view of a can decorator;

FIG. 2A is a perspective view of an ink station assembly of the presently disclosed technology;

FIG. 2B is a cross-sectional view of an ink station assembly of FIG. 2A along line A-A in FIG. 2A;

FIG. 3 is an exploded view of an ink station washing assembly of the presently disclosed technology;

FIG. 4A is a side view of an ink station washing assembly of the presently disclosed technology;

FIG. 4B is a perspective view of an ink station washing assembly of the presently disclosed technology;

FIG. 4C is a perspective view of an ink station washing assembly of the presently disclosed technology;

FIG. 5A is a side view of an ink station washing assembly of the presently disclosed technology;

FIG. 5B is a perspective view of an ink station washing assembly of the presently disclosed technology;

FIG. 5C is a perspective view of an ink station washing assembly of the presently disclosed technology;

FIG. 6A is a side view of an ink station washing assembly of the presently disclosed technology;

FIG. 6B is a perspective view of an ink station washing assembly of the presently disclosed technology;

FIG. 6C is a perspective view of an ink station washing assembly of the presently disclosed technology;

FIG. 7A is a side view of an ink station washing assembly of the presently disclosed technology;

FIG. 7B is a perspective view of an ink station washing assembly of the presently disclosed technology;

FIG. 7C is a perspective view of an ink station washing assembly of the presently disclosed technology;

FIG. 8 is a cross-sectional view of an ink station assembly; and

FIG. 9 is a block diagram of an ink station washing assembly of the presently disclosed technology.

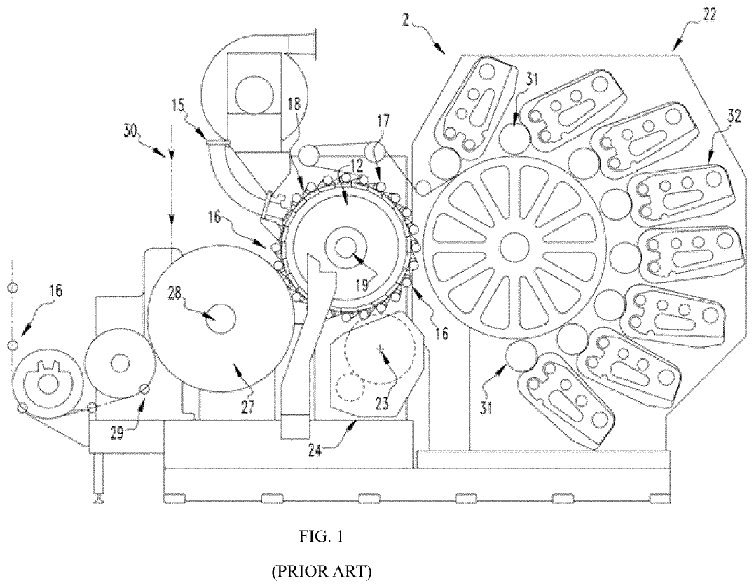

### DETAILED DESCRIPTION OF THE INVENTION

It will be appreciated that the specific elements illustrated in the figures herein and described in the following specification are simply exemplary embodiments of the disclosed concept, which are provided as non-limiting examples solely for the purpose of illustration.

Therefore, specific dimensions, orientations, assembly, number of components used, embodiment configurations and other physical characteristics related to the embodiments disclosed herein are not to be considered limiting on the scope of the disclosed concept.

Directional phrases used herein, such as, for example, clockwise, counterclockwise, left, right, top, bottom, upwards, downwards and derivatives thereof, relate to the orientation of the elements shown in the drawings and are not limiting upon the claims unless expressly recited therein.

As used herein, the singular form of “a,” “an,” and “the” include plural references unless the context clearly dictates otherwise.

As used herein, “structured to [verb]” means that the identified element or assembly has a structure that is shaped, sized, disposed, coupled and/or configured to perform the identified verb. For example, a member that is “structured to move” is movably coupled to another element and includes elements that cause the member to move or the member is otherwise configured to move in response to other elements or assemblies. As such, as used herein, “structured to [verb]” recites structure and not function. Further, as used herein, “structured to [verb]” means that the identified element or assembly is intended to, and is designed to, perform the identified verb. Thus, an element that is merely capable of performing the identified verb but which is not intended to, and is not designed to, perform the identified verb is not “structured to [verb].”

As used herein, “associated” means that the elements are part of the same assembly and/or operate together, or, act upon/with each other in some manner. For example, an automobile has four tires and four hub caps. While all the elements are coupled as part of the automobile, it is understood that each hubcap is “associated” with a specific tire.

As used herein, a “coupling assembly” includes two or more couplings or coupling components. The components of a coupling or coupling assembly are generally not part of the same element or other component. As such, the components of a “coupling assembly” may not be described at the same time in the following description.

As used herein, a “coupling” or “coupling component(s)” is one or more component(s) of a coupling assembly. That is, a coupling assembly includes at least two components that are structured to be coupled together. It is understood that the components of a coupling assembly are compatible with each other. For example, in a coupling assembly, if one coupling component is a snap socket, the other coupling component is a snap plug, or, if one coupling component is a bolt, then the other coupling component is a nut.

As used herein, a “fastener” is a separate component structured to couple two or more elements. Thus, for example, a bolt is a “fastener” but a tongue-and-groove coupling is not a “fastener.” That is, the tongue-and-groove elements are part of the elements being coupled and are not a separate component.

As used herein, the statement that two or more parts or components are “coupled” shall mean that the parts are joined or operate together either directly or indirectly, i.e., through one or more intermediate parts or components, so long as a link occurs. As used herein, “directly coupled” means that two elements are directly in contact with each other. As used herein, “fixedly coupled” or “fixed” means that two components are coupled so as to move as one while maintaining a constant orientation relative to each other. Accordingly, when two elements are coupled, all portions of those elements are coupled. A description, however, of a specific portion of a first element being coupled to a second element, e.g., an axle first end being coupled to a first wheel, means that the specific portion of the first element is disposed closer to the second element than the other portions thereof. Further, an object resting on another object held in place only by gravity is not “coupled” to the lower object unless the upper object is otherwise maintained substantially in place. That is, for example, a book on a table is not coupled thereto, but a book glued to a table is coupled thereto.

As used herein, the phrase “removably coupled” or “temporarily coupled” means that one component is coupled with another component in an essentially temporary manner. That is, the two components are coupled in such a way that the joining or separation of the components is easy and would not damage the components. For example, two components secured to each other with a limited number of readily accessible fasteners, i.e., fasteners that are not difficult to access, are “removably coupled” whereas two components that are welded together or joined by difficult to access fasteners are not “removably coupled.” A “difficult to access fastener” is one that requires the removal of one or more other components prior to accessing the fastener wherein the “other component” is not an access device such as, but not limited to, a door.

As used herein, “temporarily disposed” means that a first element(s) or assembly(ies) is resting on a second element(s) or assembly(ies) in a manner that allows the first element/assembly to be moved without having to decouple or otherwise manipulate the first element. For example, a book simply resting on a table, i.e., the book is not glued or fastened to the table, is “temporarily disposed” on the table.

As used herein, “operatively coupled” means that a number of elements or assemblies, each of which is movable between a first position and a second position, or a first configuration and a second configuration, are coupled so that as the first element moves from one position/configuration to the other, the second element moves between positions/configurations as well. It is noted that a first element may be “operatively coupled” to another without the opposite being true.

As used herein, a “path of travel” or “path,” when used in association with an element that moves, includes the space an element moves through when in motion. As such, any element that moves inherently has a “path of travel” or “path.” Further, a “path of travel” or “path” relates to a motion of one identifiable construct as a whole relative to another object. For example, assuming a perfectly smooth road, a rotating wheel (an identifiable construct) on an automobile generally does not move relative to the body (another object) of the automobile. That is, the wheel, as a whole, does not change its position relative to, for example, the adjacent fender. Thus, a rotating wheel does not have a “path of travel” or “path” relative to the body of the automobile. Conversely, the air inlet valve on that wheel (an identifiable construct) does have a “path of travel” or “path” relative to the body of the automobile. That is, while the wheel rotates and is in motion, the air inlet valve, as a whole, moves relative to the body of the automobile.

As used herein, the statement that two or more parts or components “engage” one another means that the elements exert a force or bias against one another either directly or through one or more intermediate elements or components. Further, as used herein with regard to moving parts, a moving part may “engage” another element during the motion from one position to another and/or may “engage” another element once in the described position. Thus, it is understood that the statements, “when element A moves to element A first position, element A engages element B,” and “when element A is in element A first position, element A engages element B” are equivalent statements and mean that element A either engages element B while moving to element A first position and/or element A either engages element B while in element A first position.

As used herein, “operatively engage” means “engage and move.” That is, “operatively engage” when used in relation to a first component that is structured to move a movable or rotatable second component means that the first component applies a force sufficient to cause the second component to move. For example, a screwdriver may be placed into contact with a screw. When no force is applied to the screwdriver, the screwdriver is merely “temporarily coupled” to the screw. If an axial force is applied to the screwdriver, the screwdriver is pressed against the screw and “engages” the screw. However, when a rotational force is applied to the screwdriver, the screwdriver “operatively engages” the screw and causes the screw to rotate. Further, with electronic components, “operatively engage” means that one component controls another component by a control signal or current.

As used herein, the term “number” shall mean one or an integer greater than one (i.e., a plurality). That is, for example, the phrase “a number of elements” means one element or a plurality of elements.

As used herein, in the phrase “[x] moves between its first position and second position,” or, “[y] is structured to move [x] between its first position and second position,” “[x]” is the name of an element or assembly. Further, when [x] is an element or assembly that moves between a number of positions, the pronoun “its” means “[x],” i.e., the named element or assembly that precedes the pronoun “its.”

As used herein, “about” in a phrase such as “disposed about [an element, point or axis]” or “extend about [an element, point or axis]” or “[X] degrees about an [an element, point or axis],” means encircle, extend around, or measured around. When used in reference to a measurement or in a similar manner, “about” means “approximately,” i.e., in an approximate range relevant to the measurement as would be understood by one of ordinary skill in the art.

As used herein, a “radial side/surface” for a circular or cylindrical body is a side/surface that extends about, or encircles, the center thereof or a height line passing through the center thereof. As used herein, an “axial side/surface” for a circular or cylindrical body is a side that extends in a plane extending generally perpendicular to a height line passing through the center. That is, generally, for a cylindrical soup can, the “radial side/surface” is the generally circular sidewall and the “axial side(s)/surface(s)” are the top and bottom of the soup can.

As used herein, a “customer side” means the side of a construct used in a container that does not contact, or could not contact, a product such as, but not limited to, a food or beverage. That is, the “customer side” of the construct is the side of the construct that, eventually, defines the exterior of a container.

As used herein, “generally” means “in a general manner” relevant to the term being modified as would be understood by one of ordinary skill in the art.

As used herein, “substantially” means “for the most part” relevant to the term being modified as would be understood by one of ordinary skill in the art.

As used herein, “at” means on and/or near relevant to the term being modified as would be understood by one of ordinary skill in the art.

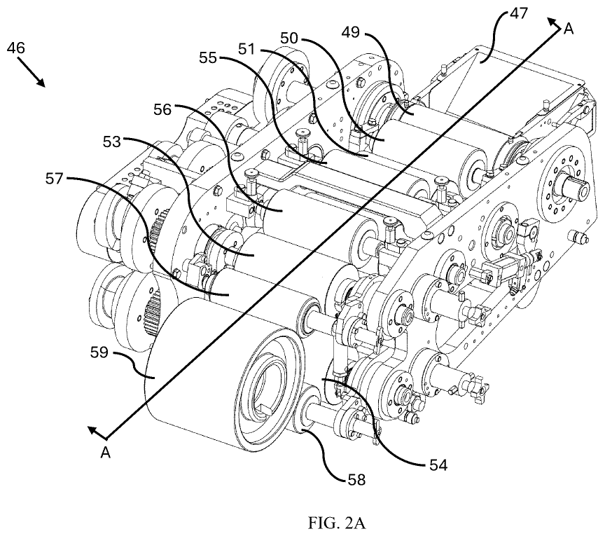

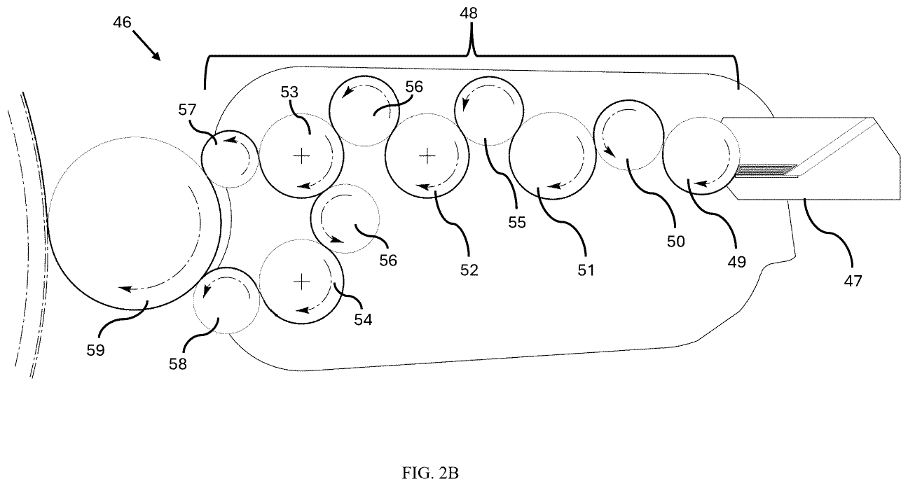

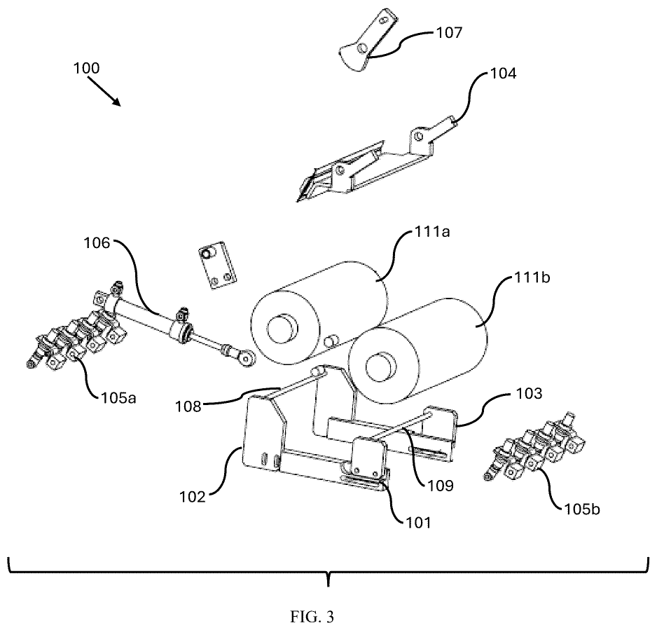

As shown in FIGS. 2A and 2B, an ink station assembly 46 can include an ink fountain 47 in operable connection with an ink roller assembly 48. The ink roller assembly 48 can include at least one or a plurality of rollers, wherein each roller fulfills a specific function. For example, in the illustrated embodiment, the ink roller assembly can include a fountain roller 49, a ductor roller 50, a distributor roller 51, at least one or a plurality of oscillating rollers, 52, 53, 54, a pair of transfer rollers 55, 56, and a pair of form rollers 57, 58. Ultimately, the ink roller assembly 48 is configured to move and refine ink from the ink fountain 47 to the printing plate 59. In turn, the printing plate 59 will transfer the ink onto one or more cans, thus decorating the can with ink.

An ink station washing assembly 100 can include a frame 101. The frame 101 can include a first end 102 and an opposing second end 103. The frame 101 is configured to be positioned underneath the ink roller assembly 48. As such, the ink station washing assembly 100 can be equipped in a single installation process in a location that will not hinder the ink refining and printing process performed by the can decorator. The frame 101 may be permanently affixed to, or temporarily disposed in, the area underneath the ink roller assembly 48. As such, the action of the ink station washing assembly 100 can be integrated structurally and functionally into the can decorating process of the can decorator. In one exemplary embodiment, the frame 101 is dimensioned to be retrofitted into an industry standard ink station roller assembly.

The ink station washing assembly 100 may further include at least one or a plurality of scrapers 104. The scraper 104 is disposed between the first end 102 of the frame 101 and the second end 103 of the frame 101. However, the scraper 104 is not necessarily physically connected to the frame 101. For example, in an exemplary embodiment of the presently disclosed technology, the scraper 104 may be physically connected to an object in the surrounding environment, such as a can decorator frame or an ink station assembly 46.

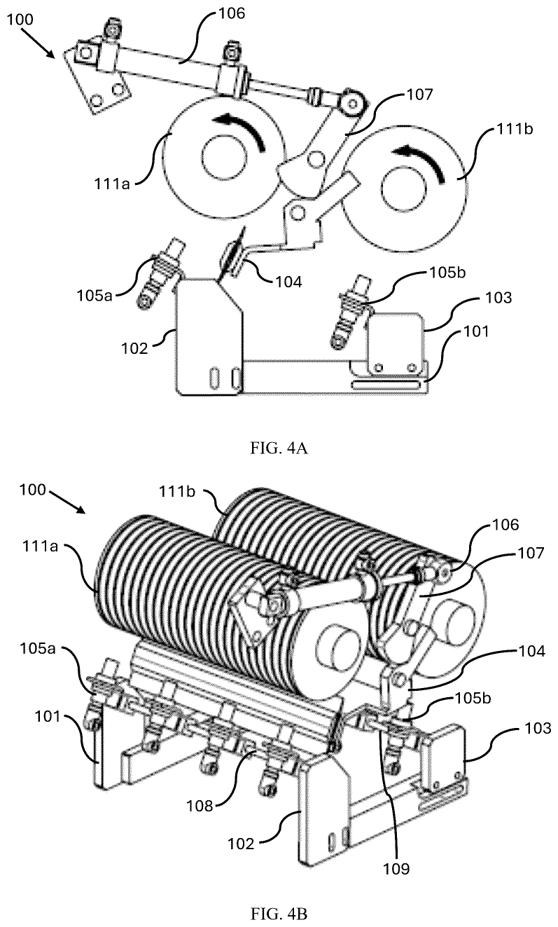

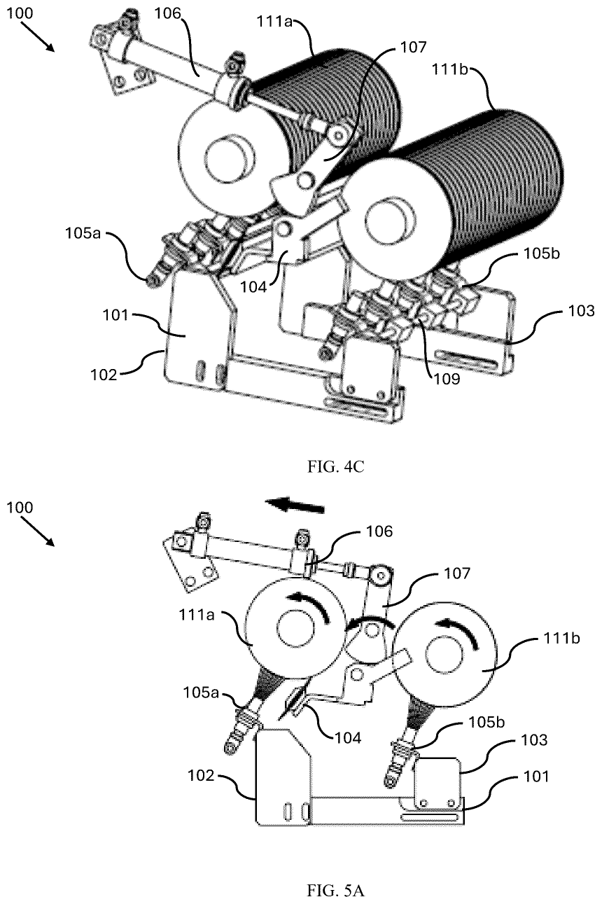

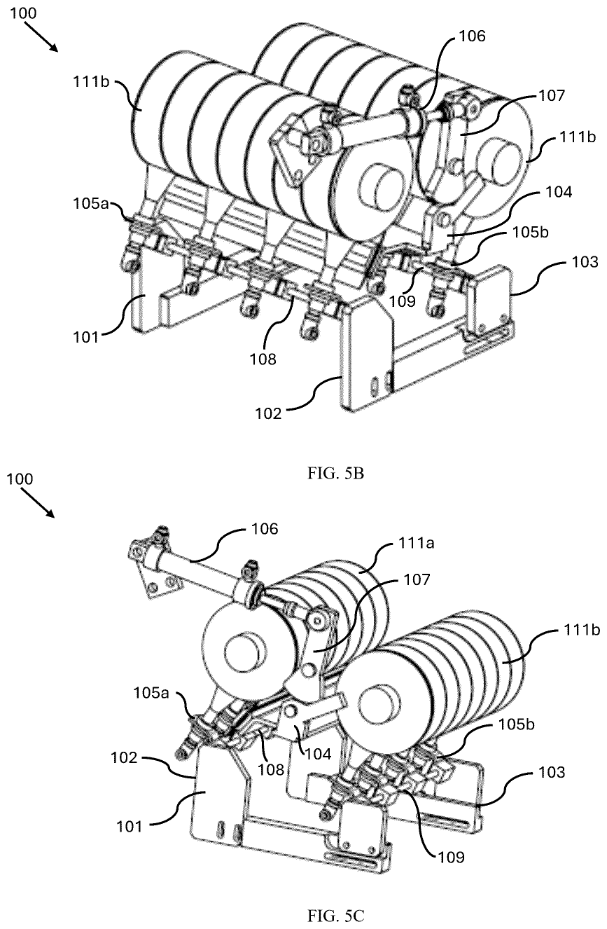

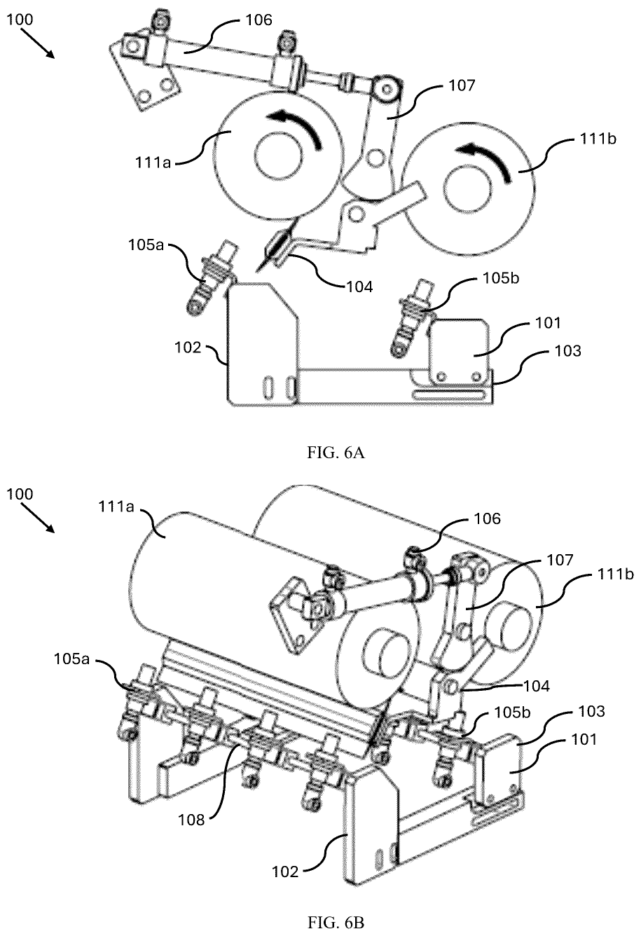

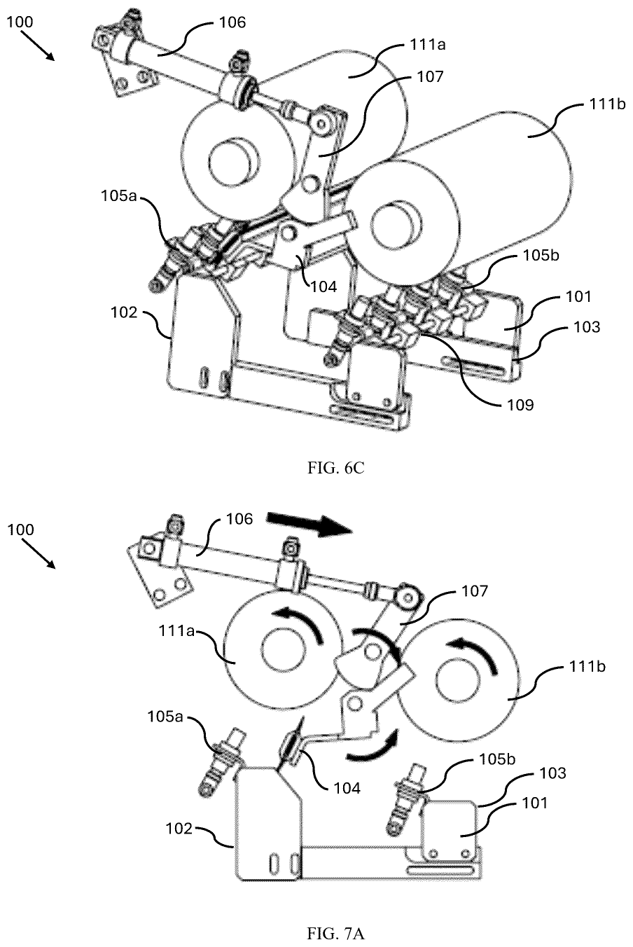

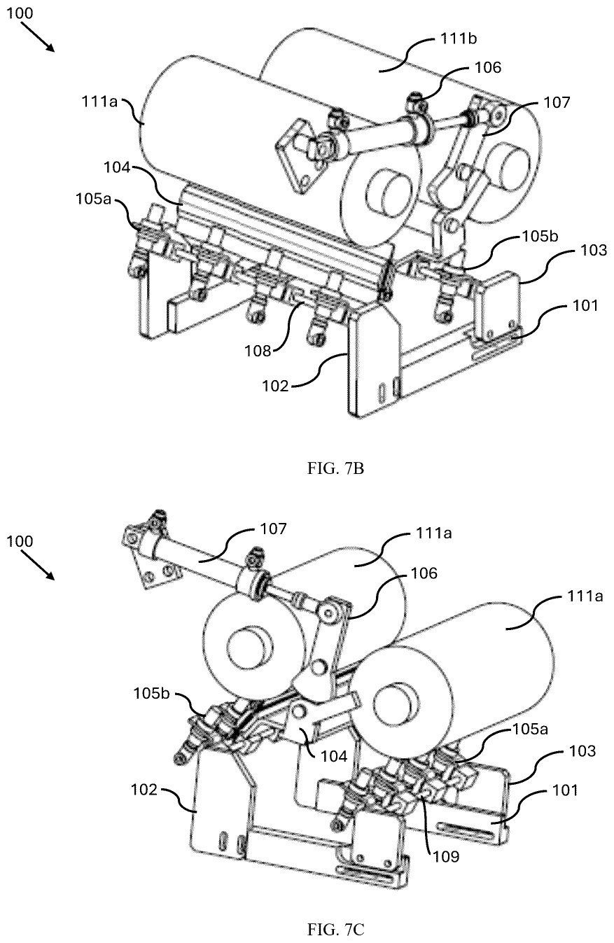

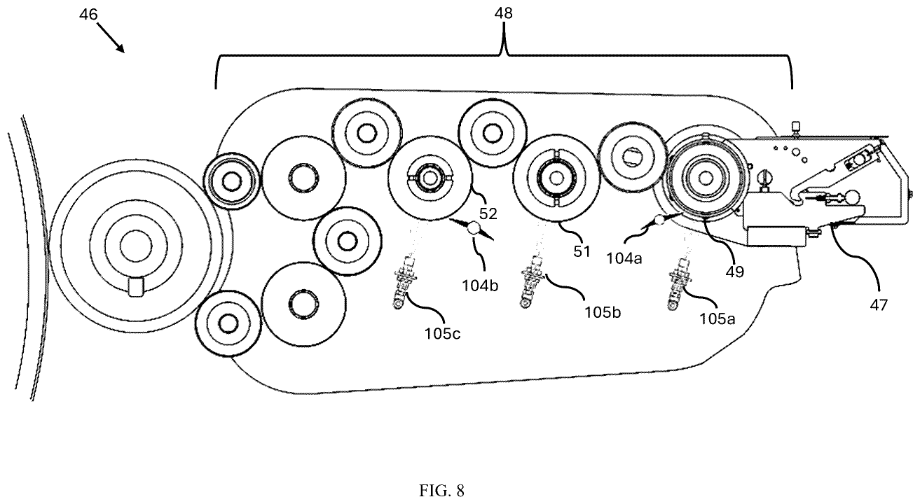

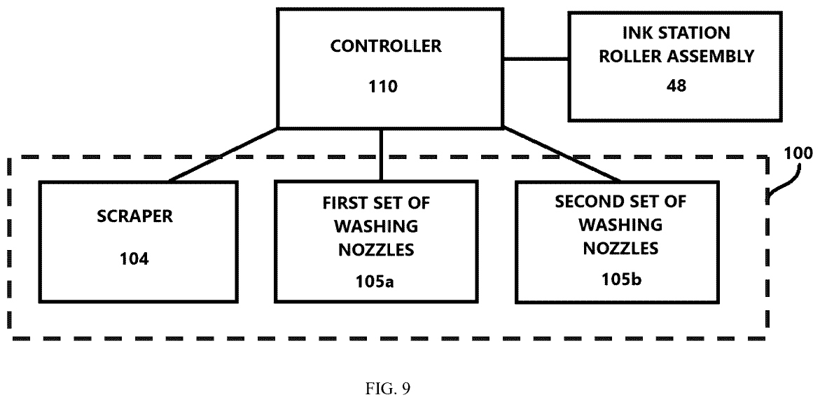

The scraper 104 is configured to move between a first position (shown, for example, in FIGS. 4A-4C and 7A-7C) and a second position (shown, for example, in FIGS. 5A-5C and 6A-6C). The first position is defined where the scraper 104 is retracted relative to the frame 101. As such, the ink roller assembly 48 is uncontacted by the scraper 104 and ink can flow freely through the ink roller assembly 48.

In contrast, the second position is defined where the scraper 104 is extended relative to the frame 101. As such, the scraper 104 is in contact with an ink roller of the ink roller assembly 48. When in contact with the ink roller, the scraper 104 will remove ink from the ink roller as the ink roller rotates in contact with the scraper 104.

The scraper 104 is movable between the first position and the second position by action of an actuator. For example, in an exemplary embodiment, the scraper 104 is movable between the first position and the second position by an air cylinder 106 in operable connection with a cam 107. An advantage to using the air cylinder 106 and the cam 107 is that the scraper 104 can be connected into a hydraulic system being utilized to power and control the ink station assembly 48.

Furthermore, the ink station washing assembly 100 further can include at least one or a plurality of washing nozzles 105a, 105b. The plurality of washing nozzles 105a, 105b are in operable connection with a fluid supply, such that the plurality of washing nozzles 105a, 105b are configured to eject a washing fluid. In the exemplary embodiment, the plurality of washing nozzles 105a, 105b can include a first set of washing nozzles 105a disposed on a first end 102 of the frame 101 and a second set of washing nozzles 105b disposed on a second end 103 of the frame 101. As such, the first set of washing nozzles 105a and the second set of washing nozzles 105b are configured to eject a washing fluid evenly onto the ink roller assembly 48 to more efficiently distribute washing fluid onto the ink rollers of the ink roller assembly 48. The plurality of washing nozzles 105a, 105b may be configured to pulse the washing fluid ejected therefrom. As such, the variable increasing and decreasing of pressure of the washing fluid may assist with the removal of ink form the ink station roller assembly 48. The pulsing of the washing fluid may be controlled by a controller 110, the result of a mechanical mechanism installed collectively or individually upon one or more washing nozzles of the plurality of washing nozzles 105a, 105b, or a combination thereof.

Specifically, in the exemplary embodiment, the first set of washing nozzles 105a are positioned towards a first roller of the ink station roller assembly 48. Furthermore, in the exemplary embodiment, the second set of washing nozzles 105b are positioned towards a second roller of the ink station roller assembly 48. The frame 101 can be dimensioned to position the first set of washing nozzles 105a towards the first roller of the ink station roller assembly 48 and the second set of washing nozzles 105b towards the second roller of the ink station washing assembly. For example, the length of the frame 101 from the first end 102 to the second end 103 may define the position at which the washing nozzles 105a, 105b eject washing fluid. Furthermore, the angle at which the washing nozzles 105a, 105b are positioned may also define the position at which the washing nozzles 105a, 105b eject washing fluid.

In one exemplary embodiment demonstrated in FIG. 8, a first set of washing nozzles 105a is placed underneath and configured to release the washing fluid onto an underside of a fountain roller 49 of the ink roller assembly 48. Furthermore, in the exemplary embodiment of FIG. 8, a second set of washing nozzles 105b is positioned underneath and configured to release the washing fluid onto an underside of a distributor roller 51. Additionally, in the exemplary embodiment of FIG. 8, a third set of washing nozzles 105c is positioned under and configured to release the washing fluid onto an underside of an oscillating roller 52 of the ink roller assembly 48. Additionally, as demonstrated in the exemplary embodiment of FIG. 8, a first scraper 104a and a second scraper 104b may be utilized to further increase the efficiency of removing ink from the ink roller assembly 48. In such an embodiment, the first scraper 104a may be positioned at the fountain roller 49 of the ink roller assembly 48 and the second scraper 104b may be positioned at one of the oscillating rollers 52 of the ink roller assembly 52. A scraper 104 and a set of washing nozzles 105 may be positioned on the same roller, such that ink may be more thoroughly and quickly cleaned from that roller. In the exemplary embodiment of FIG. 8, the first scraper 104a and the first set of washing nozzles 105a are positioned on the same roller, while the second scraper 104b and the third set of washing nozzles 105c are positioned on the same roller.

Additionally, in the exemplary embodiment, the first set of washing nozzles 105a are equidistantly placed along a first support 108 extending across the frame 101. As such, the first set of washing nozzles 105a will direct washing fluid across the entire length of the targeted first roller on the ink roller assembly 48. Furthermore, in the exemplary embodiment, the second set of washing nozzles 105b are equidistantly placed along a second support 109 extending across the frame 101. As such, the second set of washing nozzles 105b will direct washing fluid across the entire length of the targeted second roller on the ink roller assembly 48.

The plurality of washing nozzles 105a, 105b can spray washing fluid upward onto the underside of the ink roller assembly 48. In the exemplary embodiment, the scraper 104 is positioned adjacent to, and downstream from, the plurality of washing nozzles 105a, 105b, such that the washing fluid will not pass between the rollers of the ink roller assembly 48 when the scraper 104 is in the second position. Specifically, as shown in FIGS. 4A, 5A, 6A, and 7A, the roller on which the first set of washing nozzles 105a and the scraper 104 are operated rotates in a counterclockwise direction, the first set of washing nozzles 105a directs water onto an approximate 7 o'clock position and the scraper 104 contacts the roller at an approximate 5 o'clock position. Placing the scraper 104 in close proximity to the plurality of washing nozzles 105a, 105b prevents excess runoff of washing fluid from the ink roller occurring prior to the contact point of the scraper 104.

In an exemplary embodiment, the ink station washing assembly 100 further can include a controller 110. The controller 110 is in operable connection with ink station washing assembly 100. In a further exemplary embodiment, the controller 110 is also in operable connection with the ink station roller assembly 48, such that the functions of the ink station washing assembly 100 can be integrated into, or in correspondence with, the functions of the ink station roller assembly 48. The controller 110 is configured to execute a cleaning function. The cleaning function moves the scraper 104 into the second position from the first position, and disperses the washing fluid from the plurality of washing nozzles 105a, 105b.

In use, the ink station washing assembly 100 is utilized to clean ink off of an ink station roller assembly 48. The scraper 104 can be placed from the first position into the second position, such that the scraper 104 contacts the targeted ink roller of the ink station roller assembly 48. As the ink rollers of the ink station roller assembly 48 rotate, the scraper 104 will remove ink from the targeted ink roller 111a, 111b. As ink is moved from ink roller to ink roller down the ink station roller assembly 48, the ink will gradually be removed from all of the ink rollers. In an exemplary embodiment, the plurality of washing nozzles 105a, 105b eject washing fluid onto at least one targeted ink roller. The washing fluid is configured to assist in the removal of ink from the ink station roller assembly 48, such as by thinning and/or loosening the ink on the targeted ink rollers.

In a specific exemplary embodiment, a first elapsed period of time passes between the scraper 104 being moved into the second position and the plurality of washing nozzles 105a, 105b ejecting washing fluid onto the ink station roller assembly. In such an exemplary embodiment, a second elapsed period of time passes between the plurality of washing nozzles 105a, 105b being activated and the plurality of washing nozzles 105a, 105b being deactivated. In the specific exemplary embodiment, the scraper 104 is in contact with the ink station roller assembly 48 for the entirety of the first elapsed period of time and the second elapsed period of time. As such, the scraper 104 will prevent excess washing fluid from exiting the area underneath the ink station roller assembly 48. For example, the scraper 104 may block excess washing fluid from being moved above the ink station roller assembly and being displaced into the surrounding environment.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of disclosed concept which is to be given the full breadth of the claims appended and any and all equivalents thereof.

1. An ink station washing assembly comprising:
a frame comprising a first end and an opposing second end, the frame being configured to secure the ink station washing assembly to a can decorator;
a scraper disposed between the first end of the frame and the second end of the frame; and
a plurality of washing nozzles disposed on the frame,
wherein the scraper is configured to move between a first position and a second position;
wherein the first position is defined where the scraper is retracted relative to the frame such that the can decorator is uncontacted by the scraper when the scraper is in the first position, and
wherein the second position is defined where the scraper is extended relative to the frame such that the scraper is configured to contact an ink roller of a can decorator ink roller assembly when the scraper is in the second position to remove ink from a roller assembly of the can decorator.

2. The ink station washing assembly of claim 1, wherein the scraper is movable between the first position and the second position by an air cylinder in operable connection with a cam.

3. The ink station washing assembly of claim 1, wherein the plurality of washing nozzles is configured to pulse a liquid therefrom.

4. The ink station washing assembly of claim 1, wherein the plurality of washing nozzles comprises a first set of washing nozzles disposed on the first end of the frame and a second set of washing nozzles disposed on the second end of the frame.

5. The ink station washing assembly of claim 4, wherein the frame is dimensioned to position the first set of washing nozzles towards a first roller of an ink station roller assembly and to position the second set of washing nozzles towards a second roller of the ink station roller assembly.

6. The ink station washing assembly of claim 4, wherein the first set of washing nozzles are equidistantly placed along a first support extending across the frame and the second set of washing nozzles are equidistantly placed along a second support extending across the frame.

7. The ink station washing assembly of claim 1, wherein the frame is securable underneath a plurality of rollers of an ink station roller assembly.

8. The ink station washing assembly of claim 1, further comprising a controller in operable connection with the ink station washing assembly, wherein the controller is configured to execute a cleaning function, wherein the cleaning function moves the scraper into the second position and disperses a liquid from the plurality of washing nozzles.

9. The ink station washing assembly of claim 8, wherein the controller is further configured to pulse the liquid being dispersed from the plurality of washing nozzles.

10. An ink station roller assembly, comprising:
a plurality of ink rollers for a can decorator, each ink roller being configured to transfer ink onto a can body, the plurality of ink rollers being mounted onto an ink station roller assembly frame;
an ink station washing assembly affixed to the ink station roller assembly frame, the ink station washing assembly comprising
a frame comprising a first end and an opposing second end;
a scraper disposed between the first end of the frame and the second end of the frame;
a plurality of washing nozzles disposed on the frame;
wherein the scraper is configured to move between a first position and a second position;
wherein the first position is defined where the scraper is retracted relative to the frame such that a can decorator is uncontacted by the scraper when the scraper is in the first position,
wherein the second position is defined where the scraper is extended relative to the frame such that the scraper is configured to contact an ink roller of a can decorator ink roller assembly when the scraper is in the second position to remove ink from a roller assembly of the can decorator, and
wherein each washing nozzle of the plurality of washing nozzles is directed at one or more ink rollers of the plurality of ink rollers.

11. The ink station roller assembly of claim 10, wherein the scraper is movable between the first position and the second position by an air cylinder in operable connection with a cam.

12. The ink station roller assembly of claim 10, wherein the plurality of washing nozzles comprises a first set of washing nozzles disposed on the first end of the frame and a second set of washing nozzles disposed on the second end of the frame, wherein the frame is dimensioned to position the first set of washing nozzles towards a first roller of an ink station roller assembly and to position the second set of washing nozzles towards a second roller of the ink station roller assembly.

13. The ink station roller assembly of claim 10, wherein the ink station washer assembly frame and the plurality of washing nozzles are positioned underneath the plurality of ink rollers and the scraper is positioned underneath the plurality of ink rollers, wherein the scraper is downstream of the plurality of washing nozzles.

14. The ink station roller assembly of claim 10, further comprising a controller in operable connection with the plurality of ink rollers and the ink station washing assembly, wherein the controller is configured to execute a cleaning function, wherein the cleaning function rotates the plurality of ink rollers, moves the scraper into the second position and disperses a liquid from the plurality of washing nozzles.

15. The ink station roller assembly of claim 14, wherein the controller is further configured to pulse the liquid being dispersed from the plurality of washing nozzles.

16. A method of cleaning rollers in an ink station roller assembly for a can decorator, the method comprising:
installing an ink station washing assembly into an ink station roller assembly of a can decorator;
rotating a plurality of ink rollers of the ink station washing assembly;
moving a scraper of the ink station washing assembly into contact with a target ink roller of the ink station roller assembly; and
activating one or more of a plurality of washing nozzles of the ink station washing assembly such that a liquid is sprayed onto one or more ink rollers of the plurality of ink rollers.

17. The method of claim 16, further comprising:
scraping the target ink roller with the scraper for a defined period of time;
deactivating the plurality of washing nozzles; and
retracting the scraper from the target ink roller of the ink station roller assembly.

18. The method of claim 16, wherein the action of the plurality of ink rollers, the plurality of nozzles, and the scraper are controlled by a controller in operable connection with the ink station roller assembly and the ink station washing assembly.

19. The method of claim 16, further comprising:
defining a delay between when the scraper contacts the target ink roller and when one or more of the plurality of washing nozzles sprays the liquid.

20. The method of claim 16, further comprising:
pulsing the liquid sprayed from the plurality of ink rollers.
